(19) United States
(12) Patent Application Publication
(10) Pub. No.: US 2025/0299648 A1
(43) Pub. Date: Sep. 25, 2025

(54) PROCESSOR ACCESS TO COMPRESSED MULTIMEDIA DATA IN A MOBILE SYSTEM ON A CHIP

(71) Applicant: QUALCOMM Incorporated, San Diego, CA (US)

(72) Inventors: Keshava Prasad NAGARAJA, Bangalore (IN); Andrew Edmund TURNER, San Diego, CA (US); Krishnaprasad MAHENDRAKAR, Bangalore (IN); Siddesh HALAVARTHI MATH REVANA, Bangalore (IN); Sandeep AGGARWAL, Bangalore (IN)

(21) Appl. No.: 18/611,153

(22) Filed: Mar. 20, 2024

(51) Int. Cl. G09G 5/395; G06T 1/20

(52) U.S. Cl. CPC G09G 5/395; G06T 1/20; G09G 2360/121; G09G 2360/122; G09G 2360/127

(57) ABSTRACT

Aspects of the disclosure are directed to processor access to compressed multimedia data. In accordance with one aspect, the disclosure includes converting a cache line address into a two-dimensional address based on a stride width; transforming the two-dimensional address into a pixel address; and computing a tile address using the pixel address and a main memory configuration.

### TECHNICAL FIELD

This disclosure relates generally to the field of computer processor architecture, and, in particular, to processor access to multimedia data on a chip.

### BACKGROUND

An information processing system, for example, a computing platform, strives for high processing throughput and large main memory capacity. One application which requires high processing throughput is the manipulation of multimedia traffic by a central processing unit (CPU) where the multimedia traffic has been source encoded, that is, compressed, to minimize its storage demands. An improvement in processor access to such compressed multimedia traffic may be needed in many user scenarios.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides processor access to compressed multimedia traffic. Accordingly, an apparatus including: a tile address computation module configured to convert a cache line address into a two-dimensional address based on a stride width, to transform the two-dimensional address into a pixel address, and to compute a tile address using the pixel address and a main memory configuration; and an image attributes cache module coupled to the tile address computation module, the image attributes cache module configured to store one or more image attributes.

In one example, the one or more image attributes includes a compression ratio parameter. In one example, the two-dimensional address comprises a first dimension address and a second dimension address. In one example, the stride width measures a memory address distance between consecutive pixels of an image. In one example, the first dimension address depends on a remainder function of a ratio between the cache line address and the stride width. In one example, the second dimension address depends on a quotient of the cache line address and the stride width. In one example, the one or more image attributes includes a compression ratio parameter. In one example, the tile address computation module is further configured to receive one or more tile address requests. In one example, the one or more tile address requests includes one or more read requests and one or more write requests.

In one example, the apparatus further includes a tile hazard module coupled to the tile address computation module, the tile hazard module configured to check dependencies between the one or more read requests and the one or more write requests. In one example, the tile hazard module is further configured to segregate the one or more read requests and the one or more write requests. In one example, the apparatus further includes a stash/snoop address computation module coupled to the image attributes cache module, the stash/snoop address computation module configured to produce a stash address and a snoop address.

Another aspect of the disclosure provides a method including: converting a cache line address into a two-dimensional address based on a stride width; transforming the two-dimensional address into a pixel address; and computing a tile address using the pixel address and a main memory configuration.

In one example, the transforming is based on one or more image attributes, and wherein the one or more image attributes includes a compression ratio parameter. In one example, the two-dimensional address comprises a first dimension address and a second dimension address. In one example, the stride width measures a memory address distance between consecutive pixels of an image. In one example, the first dimension address depends on a remainder function of a ratio between the cache line address and the stride width. In one example, the second dimension address depends on a quotient of the cache line address and the stride width. In one example, the pixel address depends on an image format.

In one example, the method further includes retrieving a compressed tile data from a compressed memory using the tile address. In one example, the method further includes converting the compressed tile data into a cache line data using a decompression process. In one example, the method further includes receiving a memory read request with the cache line address on an input databus. In one example, the memory read request is received from a central processing unit (CPU). In one example, the input databus incorporates full data coherency utilizing synchronous data transport.

Another aspect of the disclosure provides an apparatus including: means for converting a cache line address into a two-dimensional address based on a stride width; means for retrieving a compressed tile data from a compressed memory using a tile address; means for transforming the two-dimensional address into a pixel address; and means for computing the tile address using the pixel address and a main memory configuration.

In one example, the apparatus further includes means for converting the compressed tile data into a cache line data using a decompression process; and means for receiving a memory read request with the cache line address on an input databus. In one example, the two-dimensional address comprises a first dimension address wherein the first dimension address depends on a remainder function of a ratio between the cache line address and the stride width, and a second dimension address wherein the second dimension address depends on a quotient of the cache line address and the stride width. In one example, the stride width measures a memory address distance between consecutive pixels of an image.

Another aspect of the disclosure provides a non-transitory computer-readable medium storing computer executable code, operable on a device including at least one processor and at least one memory coupled to the at least one processor, wherein the at least one processor is configured to implement processor access to compressed multimedia data, the computer executable code including: instructions for causing a computer to convert a cache line address into a two-dimensional address based on a stride width; instructions for causing the computer to retrieve a compressed tile data from a compressed memory using a tile address; instructions for causing the computer to transform the two-dimensional address into a pixel address; and instructions for causing the computer to compute the tile address using the pixel address and a main memory configuration.

In one example, the two-dimensional address comprises a first dimension address wherein the first dimension address depends on a remainder function of a ratio between the cache line address and the stride width, and a second dimension address wherein the second dimension address depends on a quotient of the cache line address and the stride width; and wherein the stride width measures a memory address distance between consecutive pixels of an image.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example signal processing block architecture.

FIG. 3 illustrates an example tile and cache line relationship.

FIG. 4 illustrates an example microarchitecture for a signal processing block.

FIG. 5 illustrates an example input databus interconnect architecture with an input databus interconnect module connecting to an input databus.

FIG. 6 illustrates an example address check module.

FIG. 7 illustrates an example image attributes cache module.

FIG. 8 illustrates an example tile address computation module read section.

FIG. 9 illustrates an example tile address computation module write section.

FIG. 10 illustrates an example image.

FIG. 11 illustrates a first example stash/snoop address computation module.

FIG. 12 illustrates a second example stash/snoop address computation module.

FIG. 13 illustrates an example tile hazard module.

FIG. 14 illustrates an example flow diagram for enabling processor access to compressed multimedia data.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

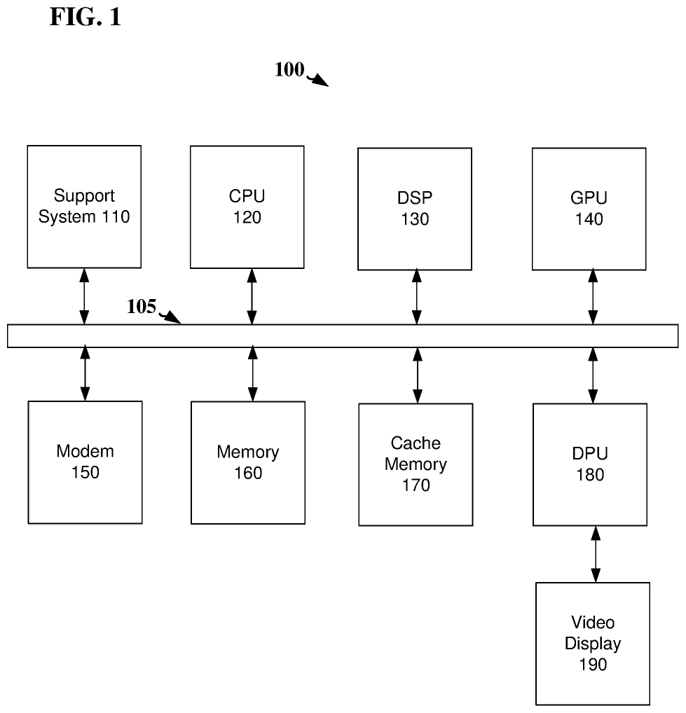

FIG. 1 illustrates an example information processing system 100. In one example, the information processing system 100 includes a plurality of processing engines, or processor cores, such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines.

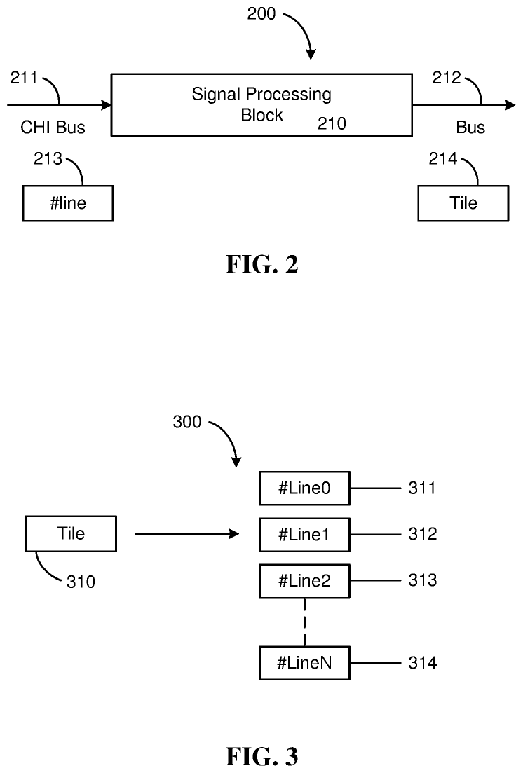

FIG. 2 illustrates an example signal processing block architecture 200. In one example, a signal processing block 210 performs signal processing operations on input data 211 and delivers output data 212. In one example, the input data 211 is transported using an input databus (e.g., a coherent hub interface, CHI bus). In one example, the input databus incorporates full data coherency (i.e., the input data 211 is transported synchronously using a common clock). In one example, the signal processing block 210 operates on a plurality of data structures such as a cache line 213 and a tile 214. In one example, the tile 214 includes a plurality of cache lines.

In one example, the output data 212 is multimedia data. In one example, multimedia refers to a plurality of media types (e.g., audio, video, text, etc.). In one example, compressed refers to a source encoding operation or data compression which reduces storage requirements for an original multimedia data by producing compressed multimedia data. In one example, the compressed multimedia data is in truncated form and requires a decompression process to recover the original multimedia data.

In one example, the original multimedia data are captured using a camera, display, microphone, video clients, etc. and compressed using a compression process to generate the compressed multimedia data. In one example, the signal processing block 210 receives the compressed multimedia data from the main memory and performs a decompression process to recover the original multimedia data. In one example, the original multimedia data is sent to a processor (e.g., CPU) for subsequent data processing and restorage (e.g., in main memory or in end point client memory, etc.).

In one example, the signal processing block 210 receives the compressed multimedia data in a tile format and decompresses the compressed multimedia data into a format which is larger than a cache line size. In one example, the tile format includes a plurality of cache lines which depends on a specific image compression format (e.g., TP10, NV12, etc.). In one example, each cache line of the plurality of cache lines is 64 bytes of data.

In one example, the processor (e.g., CPU) accesses the compressed multimedia data through the signal processing block 210 using the input databus (e.g., CHI bus). In one example, the CPU reads and writes a requested cache line from the plurality of cache lines, while the signal processing block 210 access a tile associated with the requested cache line, decompresses the tile and forwards the requested cache line to the CPU. In one example, the signal processing block 210 stashes (e.g., prefetches) remaining cache lines (i.e., cache lines that are not the requested cache line) of the tile while the CPU reads the requested cache line. In one example, the signal processing block 210 snoops (e.g., writes back) the remaining cache lines to construct the tile while the CPU writes the requested cache line.

FIG. 3 illustrates an example tile and cache line relationship 300. In one example, a tile 310 is an aggregation of cache lines. In one example, the tile 310 maps into a plurality of cache lines including a first cache line 311, a second cache line 312, a third cache line 313 and so on until a final cache line 314 (i.e., a N cache line).

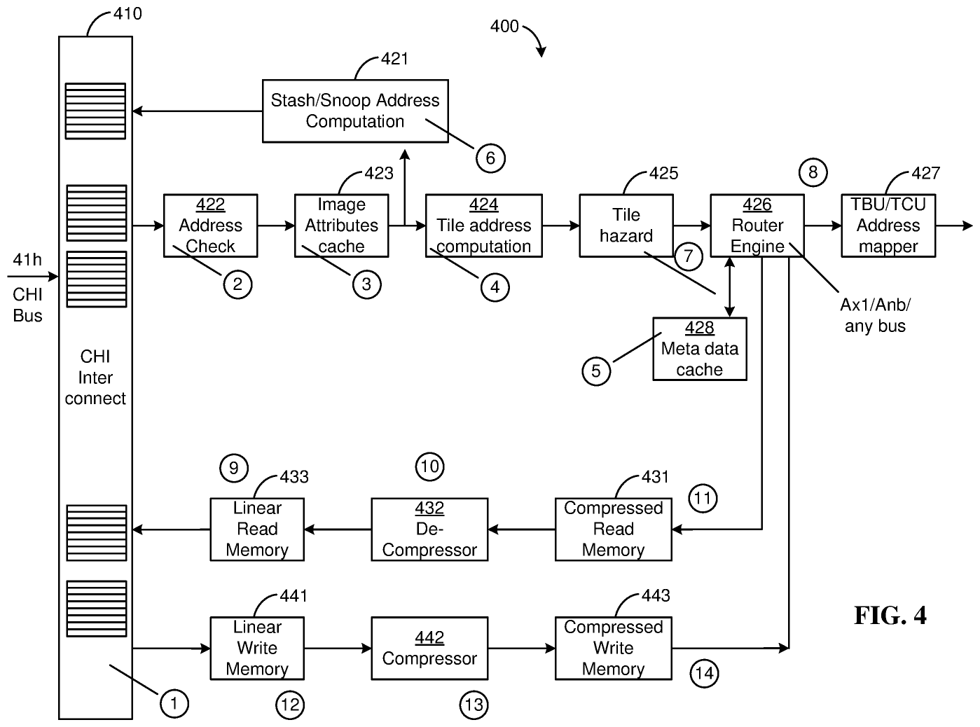

FIG. 4 illustrates an example microarchitecture 400 for a signal processing block. In one example, an input databus interconnect section 410 receives input data 411 over an input databus (e.g., a CHI bus). In one example, the input data 411 includes a memory address, a stash address, a snoop address, etc.

In one example, the databus interconnect section 410 sends an input address to an address check module 422. In one example, the address check module 422 validates the input and produces a validated input address for an image attributes cache module 423. In one example, the image attributes cache module 423 retrieves associated data and delivers it to a tile address computation module 424.

In one example, the tile address computation module 424 converts a cache line address to a tile address and sends the tile address to a tile hazard module 425. In one example, the tile hazard module 425 mediates a plurality of input tile addresses to produce a plurality of output tile addresses which are sent to a router engine 426. In one example, the router engine 426 sends the plurality of output tile addresses to main memory and local memory as well as to a translation buffer unit/translation control unit (TBU/TCU) address mapper block 427. In one example, the router engine 426 also sends metadata to a metadata cache memory 428.

In one example, the router engine 426 also outputs a tile address to a compressed read memory 431. In one example, the compressed read memory 431 retrieves a first tile data and converts it to a first cache line data using a decompression module 432 and sends the first cache line data to the input databus interconnect section 410 via a linear read memory 433 for storage. In one example, the decompression module 432 recovers the first cache line data by using a decompression process. In one example, the decompression module 432 is also known as a decompressor.

In one example, a second cache line data from the input databus interconnect section 410 is sent to a linear write memory 441 for storage. In one example, the second cache line data is sent to a compression module 442. In one example, the compression module 442 produces a second tile data using a compression process. In one example, the second tile data is sent to a compressed write memory 443 and then sent to the router engine 426. In one example, the compression module 442 is also known as a compressor.

In one example, the validated input address from the image attributes cache memory 423 is also sent to a stash/snoop address computation module 421 to produce a stash address and a snoop address. In one example, the stash address and the snoop address are sent to the input databus interconnect section 410.

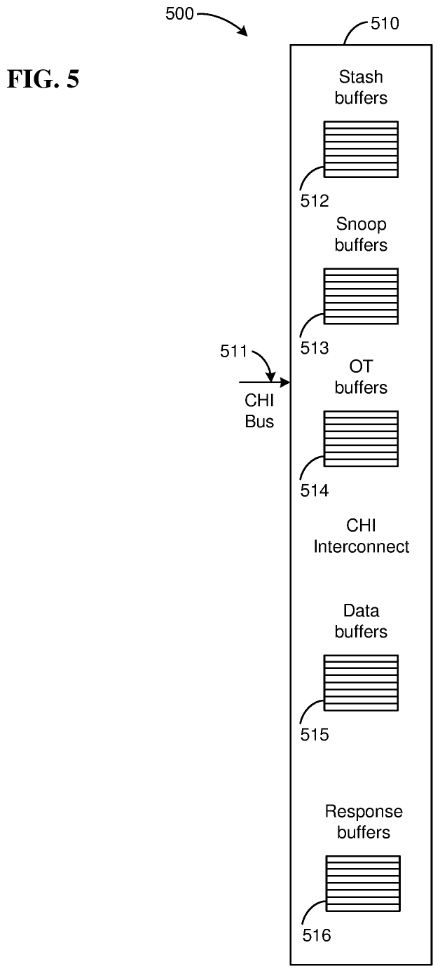

FIG. 5 illustrates an example input databus interconnect architecture 500 with an input databus interconnect module 510 connecting to an input databus, for example, a coherent hub interface (CHI) bus. In one example, the input databus interconnect module 510 receives input data 511, on the input databus. In one example, the input databus interconnect module 510 supports all databus commands (e.g., all CHI commands). In one example, the input databus interconnect module 510 includes hazard detection logic to detect a plurality of hazards. In one example, the plurality of hazards includes a read vs read (RD vs RD) hazard, a write vs write (WR vs WR) hazard, a read vs write (RD vs WR) hazard, a write vs read (WR vs RD) hazard, a read vs stash (RD vs stash) hazard, a write vs stash (WR vs stash) hazard, a read vs snoop (RD vs snoop) hazard, a write vs snoop (WR vs snoop) hazard, etc. In one example, the plurality of hazards include a collision between two actors which operate on a same memory address.

In one example, the input databus interconnect module includes stash buffers 512, snoop buffers 513, OT (outstanding transaction) buffers 514, data buffers 515 and response buffers 516. In one example, the stash buffers 512 store stash addresses. For example, the stash buffers store remaining cache line addresses while reading. In one example, the snoop buffers 513 store remaining cache line addresses while writing. In one example, the stash buffers 512 and snoop buffers 513 store addresses of additional cache lines of a tile.

In one example, the OT buffers 514 store incoming read/write commands with a variable number of OT support possible. In one example, the data buffers 515 and response buffers 516 support back pressure and avoid input databus protocol violations. For example, the input databus protocol may include rules for master/slave communication and may include checks on protocol rule compliance.

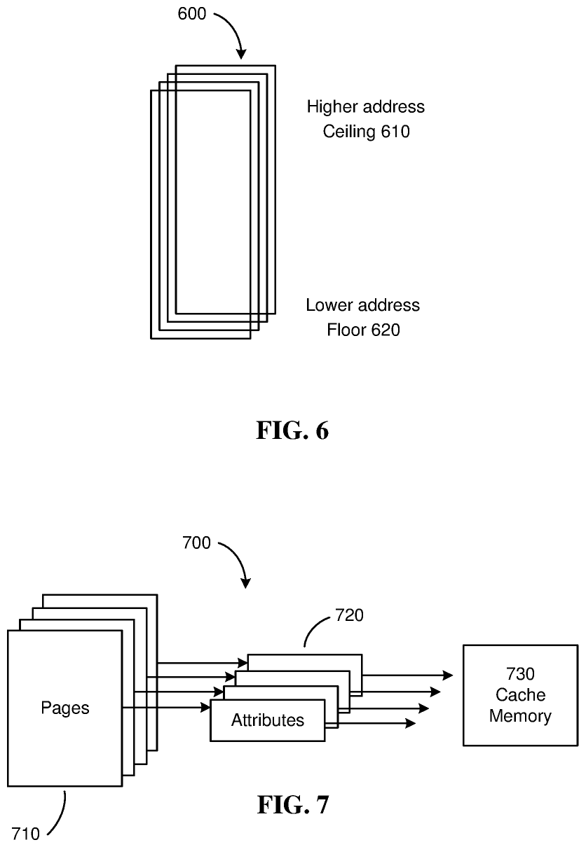

FIG. 6 illustrates an example address check module 600. In one example, the address check module 600 includes a higher address 610 or an address ceiling. In one example, the address check module 600 includes a lower address 620 or an address floor.

In one example, each input data (e.g., CHI address) received from a central processing unit (CPU) into an input databus interconnect module is processed through the address check module 600. In one example, the address check module 600 includes a plurality of address pages with a designated memory region defined by the higher address 610 and the lower address 620.

In one example, the plurality of address pages may be set using software registers. In one example, if the input data (e.g., CHI address) is determined to be outside the designated memory region (i.e., having an address greater than the higher address 610 or lower than the lower address 620), then the input data is rejected and subsequent processing will not occur.

FIG. 7 illustrates an example image attributes cache module 700. In one example, the image attributes cache module 700 retrieves associated data from cache memory and delivers it to a tile address computation module. In one example, the image attributes cache module 700 includes a plurality of pages 710, a plurality of attributes 720 and a cache memory 730.

In one example, each page of the plurality of pages 710 contains its own image attribute since each page is mapped to an image. In one example, image attributes are stored in end user memory (e.g., DDR memory, client cache memory, etc.). In one example, image attributes may be used to describe image qualities such as image format (e.g., TP10, NV12, RGBA, etc.), start address of an actual image, start address of image metadata (e.g., compression format), image height, image width, etc. In one example, image attributes may be stored in the cache memory 730 with any replacement policy. In one example, if the image attributes are not stored in the cache memory 730, the image attributes may be retrieved from main memory (e.g., DDR memory).

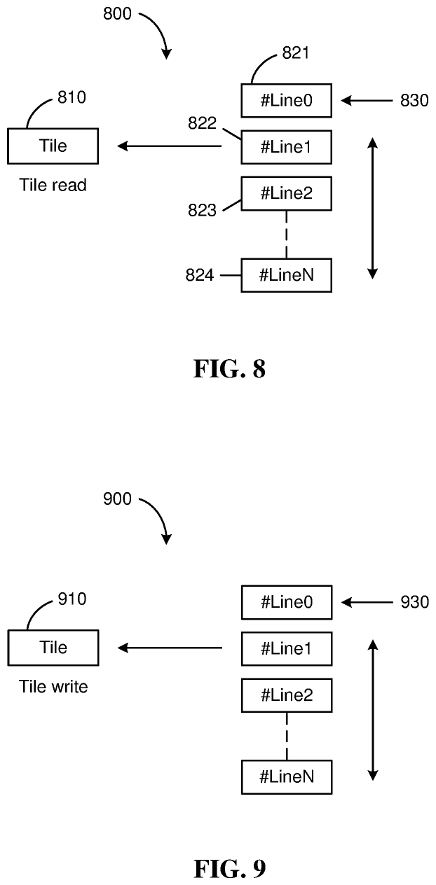

FIG. 8 illustrates an example tile address computation module read section 800. In one example, the tile address computation module read section 800 includes a tile address 810 and a plurality of stashed line addresses 820. In one example, the plurality of stashed line addresses 820 includes a first stashed line address 821 (e.g., #line0), a second stashed line address 822 (e.g., #line1), a third stashed line address 823 (e.g., #line2), and so on, until a last stashed line address 824 (e.g., #lineN). In one example, a requested read line request 830 is received by the tile address computation module read section 800 and is used to read the tile address 810.

In one example, each tile address contains a plurality of cache line addresses. For example, given the first stashed line address 821, subsequent stashed line addresses may be computed using knowledge of a quantity of bytes per line and a stride width of an image. In one example, each tile address may contain the plurality of cache line addresses arranged in a vertical manner (per FIG. 8) or in a horizontal manner or in a hybrid vertical/horizontal manner. In one example, the stride width is a measure of a memory address distance between consecutive pixels of an image. In one example, the stride width may be specified in bytes.

FIG. 9 illustrates an example tile address computation module write section 900. In one example, the tile address computation module write section 900 includes a tile address 910 and a plurality of snooped line addresses 920. In one example, the plurality of snooped line addresses 920 includes a first snooped line address 921 (e.g., #line0), a second snooped line address 922 (e.g., #line1), a third snooped line address 923 (e.g., #line2), and so on, until a last snooped line address 924 (e.g., #lineN). In one example, a requested write line request 930 is received by the tile address computation module write section 900 and is used to write the tile address 910.

In one example, computation of each tile address from cache line addresses may involve a nonlinear equation and may depend on a main memory (e.g., DDR memory) configuration. For example, a pixel address (Xpix, Ypix) may be determined by a product of a cache line address X and a byte scaling factor and by a vertical address Y. For example, once the pixel address (Xpix, Ypix) is computed, a final tile address (Xindex, Yindex) may depend on the main memory configuration. In one example, for RGBA image format, the pixel size is 4 bytes. The main memory configuration indicates a number of channels used in the main memory.

In one example, if the main memory has 8 channels, then the final tile address (Xindex, Yindex) is computed as follows for RGBA image format:
XIndex={Xpix[end:6],Xpix[5],
Xpix[4] xor Ypix[2] xor Xpix[6] xor Ypix[4],
Xpix[5] xor Xpix[4] xor Ypix[6] xor Ypix[2],
Xpix[4] xor Ypix[3], Xpix[3], Xpix{2], Ypix[I], Xpix[I], Ypix[0]}

In one example, if the main memory has 4 channels, then the final tile address (Xindex, Yindex) is computed as follows for RGBA image format:
XIndex={Xpix[end:6],Xpix[5], Xpix[4] xor Ypix[2],
Xpix[5] xor Xpix[4] xor Ypix[6] xor Ypix[2],
Xpix[4] xor Ypix[3], Xpix[3], Xpix{2], Ypix[1], Xpix[1], Ypix[0]}
YIndex={Ypix[end:4], 4′h0} //means last 4 bits are zeroed or 32 bit alignment
(Note { } indicates concatenation operator and “xor” indicates XOR operation.) Tile address=YIndex*stride width (in bytes)+XIndex*pixel size (in bytes)

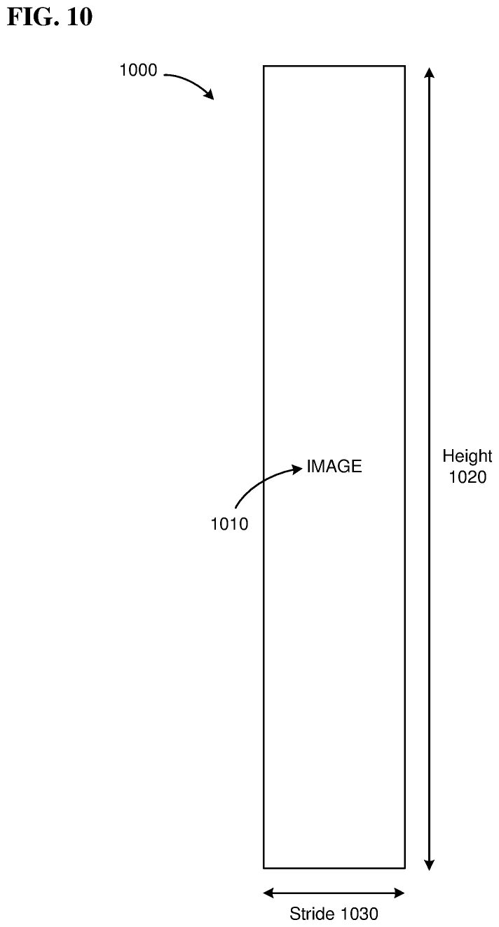

FIG. 10 illustrates an example image 1000. The example image 1000 includes an image block 1010 with a height 1020 and a stride width 1030. In one example, computation of a tile address from a cache line address for the image 1000 may be executed by the following sequence:
1. Convert a cache line address into a two-dimensional (e.g., x, y) address with:
   i. x=remainder (cache line address/stride width in bytes); i.e., divide cache line address by stride width in bytes and obtain remainder.
   ii. y=quotient (cache line address/stride width in bytes); i.e., divide cache line address by stride width in bytes and obtain quotient.
2. Convert the two-dimensional (e.g., x, y) address into pixel address (Xpix, Ypix) with:
   i. Xpix=X*(number of bytes per line/BPP), where BPP=bytes per pixel.
   ii. Ypix=Y.
3. Compute tile address from pixel address using a main memory (e.g. DDR memory) configuration.
   In one example, the bytes per pixel (BPP) may depend on image format, such as RGBA, NV12, TP10, etc.

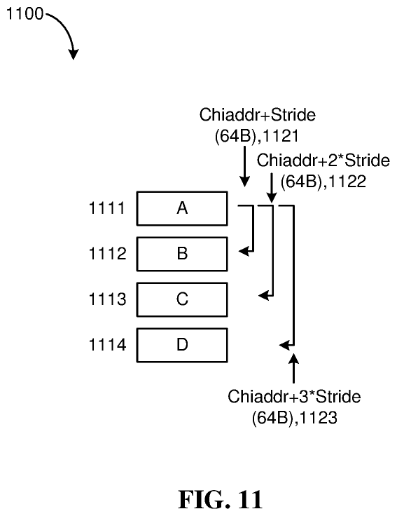

FIG. 11 illustrates a first example stash/snoop address computation module 1100. In one example, the first example stash/snoop address computation module 1100 is adapted for a first image format, for example, an RGBA format with four lines per tile. In one example, the first example stash/snoop address computation module 1100 includes a first line 1111, a second line 1112, a third line 1113, and a fourth line 1114. In one example, the first line 1111, the second line 1112, the third line 1113, and the fourth line 1114 are part of one tile.

In one example, the first line 1111 has a first address specified by a cache line address (e.g., chiaddr) which specifies a requested read line. In one example, the second line 1112 has a second address 1121 specified by an addition of the cache line address and a stride width (e.g., chiaddr+stride). For example, the stride width may be 64 bytes (64 B). In one example, the third line 1113 has a third address 1122 specified by an addition of the cache line address and twice the stride width (e.g., chiaddr+2*stride). In one example, the fourth line 1114 has a fourth address 1123 specified by an addition of the cache line address and three times the stride width (e.g., chiaddr+3*stride). In one example, an Nth line has an Nth address specified by an addition of the cache line address and (N−1) times the stride width. In one example, the stride width is obtained from an image attributes cache module.

In one example, FIG. 11 shows the first line 1111 specified by the requested read line. In one example, any other line (e.g., second line 1112, third line 1113, fourth line 1114, etc.) may instead be specified by the requested read line (i.e., cache line address) and other stash/snoop addresses may be generated by adding an appropriate stride width multiple to the cache line address.

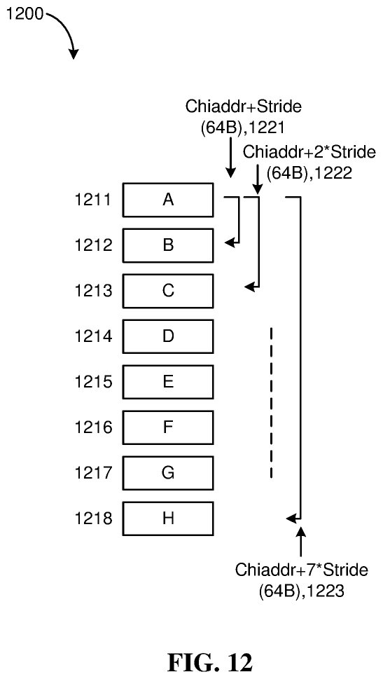

FIG. 12 illustrates a second example stash/snoop address computation module 1200. In one example, the second example stash/snoop address computation module 1200 is adapted for a second image format, for example, an NV12 format with eight lines per tile. In one example, the second example stash/snoop address computation module 1200 includes a first line 1211, a second line 1212, a third line 1213, a fourth line 1214, a fifth line 1215, a sixth line 1216, a seventh line 1217 and an eighth line 1218. In one example, the first line 1211, the second line 1212, the third line 1213, the fourth line 1214, the fifth line 1215, the sixth line 1216, the seventh line 1217 and the eighth line 1218 are part of one tile.

In one example, the first line 1211 has a first address specified by a cache line address (e.g., chiaddr) which specifies a requested read line. In one example, the second line 1212 has a second address 1221 specified by an addition of the cache line address and a stride width (e.g., chiaddr+stride). For example, the stride width may be 64 bytes (64 B). In one example, the third line 1213 has a third address 1222 specified by an addition of the cache line address and twice the stride width (e.g., chiaddr+2*stride). In one example, the eighth line 1218 has an eighth address 1223 specified by an addition of the cache line address and seven times the stride width (e.g., chiaddr+7*stride). In one example, an Nth line has an Nth address specified by an addition of the cache line address and (N−1) times the stride width. In one example, the stride width is obtained from an image attributes cache module.

In one example, FIG. 12 shows the first line 1211 specified by the requested read line. In one example, any other line (e.g., second line 1212, third line 1213, etc.) may instead be specified by the requested read line (i.e., cache line address) and other stash/snoop addresses may be generated by adding an appropriate stride width multiple to the cache line address.

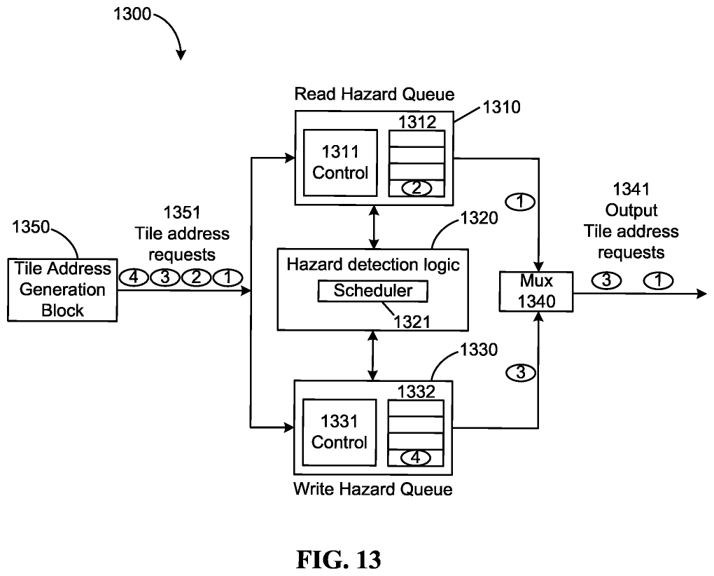

FIG. 13 illustrates an example tile hazard module 1300. In one example, the tile hazard module 1300 receives tile address requests 1351 from a tile address computation module 1350. In one example, the tile hazard module 1300 includes a read hazard queue 1310, a hazard detection logic 1320, a write hazard queue 1330 and a multiplexer 1340. In one example, the multiplexer 1340 transmits output tile requests 1341 in an order determined by the hazard detection logic 1320.

In one example, the read hazard queue 1310 includes a read control logic 1311 and a read hazard queue buffer 1312. In one example, the read hazard queue 1310 stores read dependent reads and write dependent reads.

In one example, the hazard detection logic 1320 includes a scheduler 1321 which checks dependencies between read requests and write requests and segregates read requests and write requests.

In one example, the write hazard queue 1330 includes a write control logic 1331 and a write hazard queue buffer 1332. In one example, the write hazard queue 1330 stores write dependent writes and read dependent writes.

In FIG. 13, for example, the tile address requests 1351 (e.g., request 1, request 2, request 3, request 4) may include a first read request, a second read request, a first write request and a second write request. In one example, the tile address requests 1351 are received in the following order: the first read request, the second read request, the first write request and the second write request. In one example, the tile hazard module 1300 executes the following operational sequence:
1. When the first read request is received by the tile hazard module 1300, it is routed to the read hazard queue 1310. Since the first read request is the first tile address read request received, it is sent to the multiplexer 1340 for transmission as part of the output tile requests 1341.
2. When the second read request is received by the tile hazard module 1300, it is routed to the read hazard queue 1310. In one example, the scheduler 1321 determines a hazard exists with the first read request (i.e., previous read request) and sends the second read request to the read hazard queue 1310.
3. When the first write request is received by the tile hazard module 1300, it is routed to the write hazard queue 1330. Since the first write request is the first tile address write request received, it is sent to the multiplexer 1340 for transmission as part of the output tile requests 1341.
4. When the second write request is received by the tile hazard module 1300, it is routed to the write hazard queue 1330. In one example, the scheduler 1321 determines a hazard exists with the first write request (i.e., previous write request) and sends the second write request to the write hazard queue 1330.
5. The second read request is released from the read hazard queue 1310 after the first read request is completed in a subsequent processing block. The second write request is released from the write hazard queue 1330 after the first write request is completed in the subsequent processing block.

In one example, a metadata cache memory stores metadata, where the metadata describes a compression ratio parameter of the tile. For example, the compression ratio parameter is needed for compression and decompression processing. In one example, an image includes both tile data and metadata.

In one example, the metadata may be of any fixed length and may be stored in the metadata cache memory with any replacement policy. In one example, prior to reading the tile data, read the metadata first to obtain the compression ratio parameter and then read the tile data. In one example, while writing the tile data, write the tile data and write the metadata in parallel to the metadata cache memory. In one example, if there are a plurality of metadata which indicates a plurality of tiles, this indication implies a need for multi-tile hazard detection logic.

In one example, a router engine routes all tile read addresses and all tile write addresses to main memory or to another level of cache memory. In one example, if the tile is indexed by a virtual address, a translation buffer unit (TBU) may be used to convert the virtual address to a physical address. In one example, the router engine also routes tile read data to local memory to support a back pressure response. In one example, the router engine also writes tile data from local memory to main memory.

In one example, the router engine outputs a first tile address to a compressed read memory. In one example, the compressed read memory retrieves a first cache line data using a decompression module and sends the first cache line data to an input databus interconnect section via a linear read memory for storage. In one example, the decompression module recovers the cache line data by using a decompression process.

In one example, a second cache line data from the input databus interconnect section is sent to a linear write memory for storage. In one example, the second cache line data is sent to a compression module. In one example, the compression module produces a second tile data using a compression process. In one example, the second tile data is sent to a compressed write memory and then sent to the router engine.

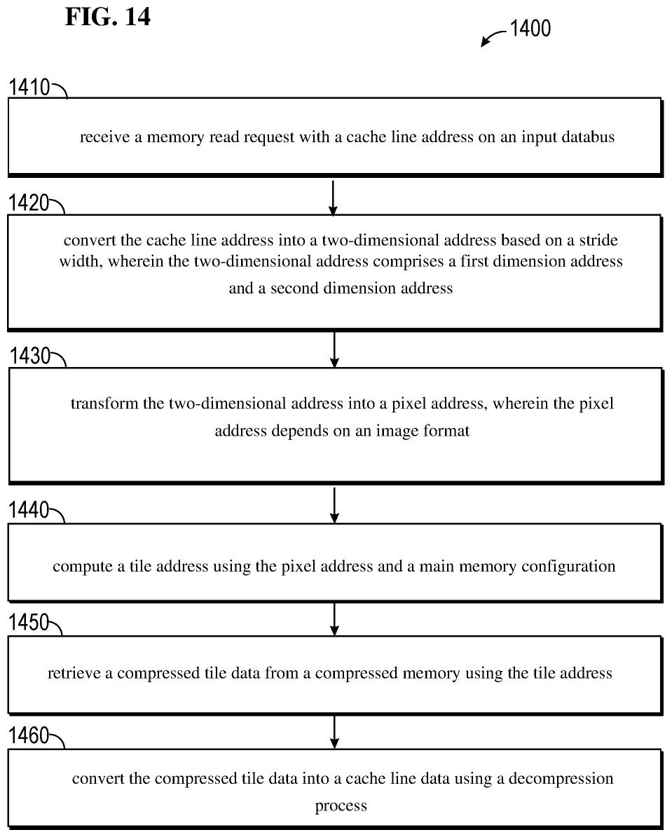

FIG. 14 illustrates an example flow diagram 1400 for enabling processor access to compressed multimedia data. In block 1410, receive a memory read request with a cache line address on an input databus. In one example, a memory read request is received with a cache line address on an input databus. In one example, the memory read request is received from a processor. In one example, the processor is a central processing unit (CPU). In one example, the input databus incorporates full data coherency. In one example, full data coherency utilizes synchronous data transport. In one example, synchronous data transport uses a common clock among all participating transport elements.

In block 1420, convert the cache line address into a two-dimensional address based on a stride width, wherein the two-dimensional address comprises a first dimension address and a second dimension address. In one example, the cache line address is converted into a two-dimensional address based on a stride width, wherein the two-dimensional address comprises a first dimension address and a second dimension address. In one example, the stride width measures a memory address distance between consecutive pixels of an image. In one example, the stride width indicates the width of the image in bytes. In one example, the stride width is measured in bytes (i.e., eight bits). In one example, the first dimension address depends on a remainder function of a ratio between the cache line address and the stride width. In one example, the second dimension address depends on a quotient of the cache line address and the stride width.

In block 1430, transform the two-dimensional address into a pixel address, wherein the pixel address depends on an image format. In one example, the two-dimensional address is transformed into a pixel address, wherein the pixel address depends on an image format. In one example, the pixel address includes a horizontal pixel address and a vertical pixel address. In one example, the transformation depends on image attributes. In one example, the image attributes are stored in an image attribute cache memory. In one example, the image attributes include a compression ratio parameter. In one example, the image attributes include a quantity of bytes per pixel (BPP). In one example, the image attributes include image format. In one example, the image format may be TP10, NV12, RGBA, etc. In one example, the horizontal pixel address is determined from a product of the first dimension address and a ratio between a quantity of bytes per line and the quantity of bytes per pixel (BPP). In one example, the vertical pixel address is determined by the second dimension address.

In block 1440, compute a tile address using the pixel address and a main memory configuration. In one example, a tile address is computed using the pixel address and a main memory configuration. In one example, the tile address computation depends on a number of bytes per cache line. In one example, the tile address computation depends on a byte scaling factor. In one example, the byte scaling factor is a quantity of bytes per pixel (BPP). In one example, computation of the tile address from cache line addresses may involve a nonlinear function of the cache line address. For example, a pixel address Xpix may be determined by a product of a cache line address X and a byte scaling factor.

In block 1450, retrieve a compressed tile data from a compressed memory using the tile address. In one example, a compressed tile data is retrieved from a compressed memory using the tile address. In one example, tile address is mediated by detecting a plurality of hazards. In one example, the plurality of hazards includes a read vs read (RD vs RD) hazard, a write vs write (WR vs WR) hazard, a read vs write (RD vs WR) hazard, a write vs read (WR vs RD) hazard, a read vs stash (RD vs stash) hazard, a write vs stash (WR vs stash) hazard, a read vs snoop (RD vs snoop) hazard, a write vs snoop (WR vs snoop) hazard, etc. In one example, the plurality of hazards includes a collision between two actors which operate on a same memory address.

In block 1460, convert the compressed tile data into a cache line data using a decompression process. In one example, the compressed tile data is converted into a cache line data using a decompression process. In one example, the conversion uses metadata stored in a metadata cache memory. In one example, the metadata includes a compression ratio parameter. In one example, the cache line data is multimedia cache line data. In one example, the cache line data is sent to the processor (e.g., CPU). And, in one example, the remaining cache lines are stashed onto the CPU (i.e., prefetching).

In one aspect, one or more of the steps for providing processor access to compressed multimedia data in FIG. 14 may be executed by one or more processors which may include hardware, software, firmware, etc. The one or more processors, for example, may be used to execute software or firmware needed to perform the steps in the flow diagram of FIG. 14. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a tile address computation module configured to convert a cache line address into a two-dimensional address based on a stride width, to transform the two-dimensional address into a pixel address, and to compute a tile address using the pixel address and a main memory configuration; and
an image attributes cache module coupled to the tile address computation module, the image attributes cache module configured to store one or more image attributes.

2. The apparatus of claim 1, wherein the one or more image attributes includes a compression ratio parameter.

3. The apparatus of claim 1, wherein the two-dimensional address comprises a first dimension address and a second dimension address.

4. The apparatus of claim 1, wherein the one or more image attributes includes a compression ratio parameter.

5. The apparatus of claim 1, wherein the tile address computation module is further configured to receive one or more tile address requests.

6. The apparatus of claim 5, wherein the one or more tile address requests includes one or more read requests and one or more write requests.

7. The apparatus of claim 6, further comprising a tile hazard module coupled to the tile address computation module, the tile hazard module configured to check dependencies between the one or more read requests and the one or more write requests.

8. The apparatus of claim 7, wherein the tile hazard module is further configured to segregate the one or more read requests and the one or more write requests.

9. The apparatus of claim 4, further comprising a stash/snoop address computation module coupled to the image attributes cache module, the stash/snoop address computation module configured to produce a stash address and a snoop address.

10. A method comprising:
converting a cache line address into a two-dimensional address based on a stride width;
transforming the two-dimensional address into a pixel address; and
computing a tile address using the pixel address and a main memory configuration.

11. The method of claim 10, wherein the transforming is based on one or more image attributes, and wherein the one or more image attributes includes a compression ratio parameter.

12. The method of claim 10, wherein the two-dimensional address comprises a first dimension address and a second dimension address.

13. The method of claim 12, wherein the stride width measures a memory address distance between consecutive pixels of an image.

14. The method of claim 13, wherein the first dimension address depends on a remainder function of a ratio between the cache line address and the stride width.

15. The method of claim 13, wherein the second dimension address depends on a quotient of the cache line address and the stride width.

16. The method of claim 12, wherein the pixel address depends on an image format.

17. The method of claim 16, further comprising retrieving a compressed tile data from a compressed memory using the tile address.

18. The method of claim 17, further comprising converting the compressed tile data into a cache line data using a decompression process.

19. An apparatus comprising:
means for converting a cache line address into a two-dimensional address based on a stride width;
means for retrieving a compressed tile data from a compressed memory using a tile address;
means for transforming the two-dimensional address into a pixel address;
means for computing the tile address using the pixel address and a main memory configuration;
means for converting the compressed tile data into a cache line data using a decompression process; and
means for receiving a memory read request with the cache line address on an input databus.

20. The apparatus of claim 19, wherein the two-dimensional address comprises a first dimension address wherein the first dimension address depends on a remainder function of a ratio between the cache line address and the stride width, and a second dimension address wherein the second dimension address depends on a quotient of the cache line address and the stride width.
